(19) United States
(12) Patent Application Publication
(10) Pub. No.: US 2007/0119501 A1
(43) Pub. Date: May 31, 2007

(54) Pressure balance valve

(76) Inventor: Thomas Pinette, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 11/290,703

(22) Filed: Nov. 30, 2005

(51) Int. Cl. G05D 11/00

(52) U.S. Cl. 137/98

(57) ABSTRACT

A valve assembly including a sleeve molded from a polymer and a spool molded from a polymer and slidably received within the sleeve.

### BACKGROUND AND SUMMARY OF THE INVENTION

The present invention relates to generally to a mixing valve and, more particularly, to a spool type pressure balance valve.

Mixing valves including pressure balancing devices are well known in the art. Such prior art mixing valves often pressure balance the hot and cold water supplies and provide for adjustment of the temperature in a mixing valve housing with a temperature adjustment control. One such mixing valve is disclosed in U.S. Pat. No. 5,725,010, the disclosure of which is expressly incorporated by reference herein.

However, there remains a need for a cost efficient and lightweight mixing valve. More particularly, there is a need for a cost efficient and lightweight spool type pressure balance valve which provides improved sealing.

According to an illustrative embodiment of the present disclosure, a valve is provided for balancing pressure between a first fluid and a second fluid. The valve includes a valve body having a first fluid inlet for receiving the first fluid, a second fluid inlet for receiving the second fluid, a first fluid outlet, a second fluid outlet, and an internal chamber in fluid communication with the first fluid inlet, the second fluid inlet, the first fluid outlet, and the second fluid outlet. A first valve member is molded from a polymer and is positioned within the chamber. The first valve member includes an inner surface defining an internal passage in fluid communication with the first fluid supply, the second fluid supply, the first fluid outlet, and the second fluid outlet. A second valve member is at least partially disposed within the internal passage of the first valve member, and is slidably moveable relative to the first valve member. The second valve member includes an outer surface, a first fluid conduit in fluid communication with the first fluid supply and the first fluid outlet, and a second fluid conduit separated from the first fluid conduit and in fluid communication with the second fluid supply and the second fluid outlet. The outer surface of the second valve member and the inner surface of the first valve member are machined to substantially the same dimension to provide a movable seal between the second valve member and the first valve member and thereby prevent the passage of fluid from the first fluid conduit to the second fluid conduit.

Illustratively, the first valve member and said second valve member further each include a plurality of apertures, wherein the apertures of the first valve member and the second valve member are selectively alignable to control the flow of water to the first and second fluid outlets. Further illustratively, at least one of the plurality of apertures are elongated. Illustratively, at least one of the plurality of apertures of the second valve member includes radially outwardly extending wall. In another illustrative embodiment, at least one of the plurality of the apertures of the first valve member includes tapered outer surfaces. In an illustrative embodiment, the second valve member further includes opposing ends, and a plurality of ribs on the ends configured to couple to a holder. Illustratively, the first valve member includes a substantially cylindrical wall defining the inner surface. Further illustratively, the first valve member includes a plurality of annular members extending radially outwardly from the substantially cylindrical wall. The first valve member further illustratively includes sealing rings supported by the annular members. Illustratively, the second valve member is molded from a polymer.

According to another illustrative embodiment of the present disclosure, a method of forming a pressure balance valve assembly is provided. The method includes the steps of injection molding a first valve member from a polymer, the first valve member including an inner surface defining an internal passage, and precision machining the inner surface of the first valve member to a first diameter. The method further comprises the steps of injection molding a second valve member from a polymer, the second valve member including an outer surface, and precision machining the outer surface of the second valve member to a second diameter, wherein the second diameter is substantially equal to the first diameter.

In an illustrative embodiment, the difference between the first diameter and the second diameter is no more than approximately 0.002 inches. Illustratively, the method comprises the additional step of subjecting the second valve member and the first valve member to a first fluid, wherein the first valve member and the second valve member expand before precision machining either one of the first or said second valve members. Further illustratively, the method comprises the additional step of providing a multiple valve member mold, and simultaneously injection molding said first and said second valve members within the multiple valve member mold. In a further illustrative embodiment, the method comprises the additional step of inserting the second valve member within the first valve member for sliding movement, wherein the outer surface of the second valve member seals against the inner surface of the first valve member.

According to another illustrative embodiment of the present disclosure, a valve assembly includes a sleeve molded from a polymer and having a precision machined inner surface defining a passage. A spool includes a precision machined outer surface which sealingly engages the inner surface of the sleeve when said spool is received within the passage of the sleeve.

Illustratively, the spool further includes a cylindrical wall defining first and second fluid conduits and a plurality of apertures. Further illustratively, at least one of the plurality of apertures is elongated. In another illustrative embodiment, at least one of the plurality of the apertures includes tapered outer surfaces. Illustratively, the spool is molded from a polymer.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative embodiment valve;

FIG. 2 is a cross-sectional view of the valve of FIG. 1 taken along line 2-2, showing the valve body and the first and second valve members;

FIG. 3 is an exploded perspective view of the valve of FIG. 1;

FIG. 4 is a side elevation view of the first valve member of the valve of FIG. 3;

FIG. 5 is a side elevation view of the second valve member of the valve of FIG. 3; and

FIG. 6 is a flow chart showing an illustrative embodiment method of forming the valve of FIG. 1.

### DETAILED DESCRIPTION OF THE DRAWINGS

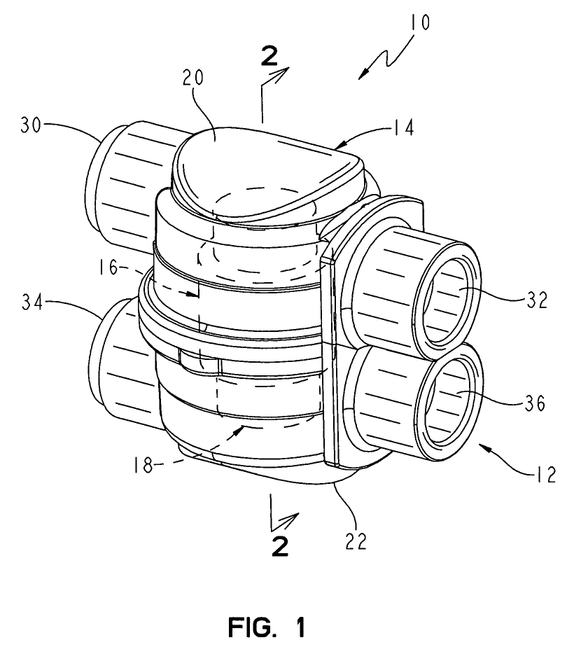

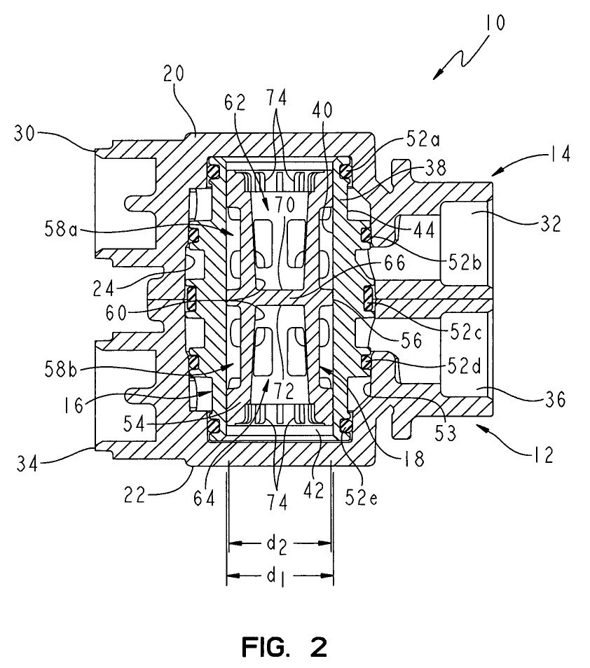

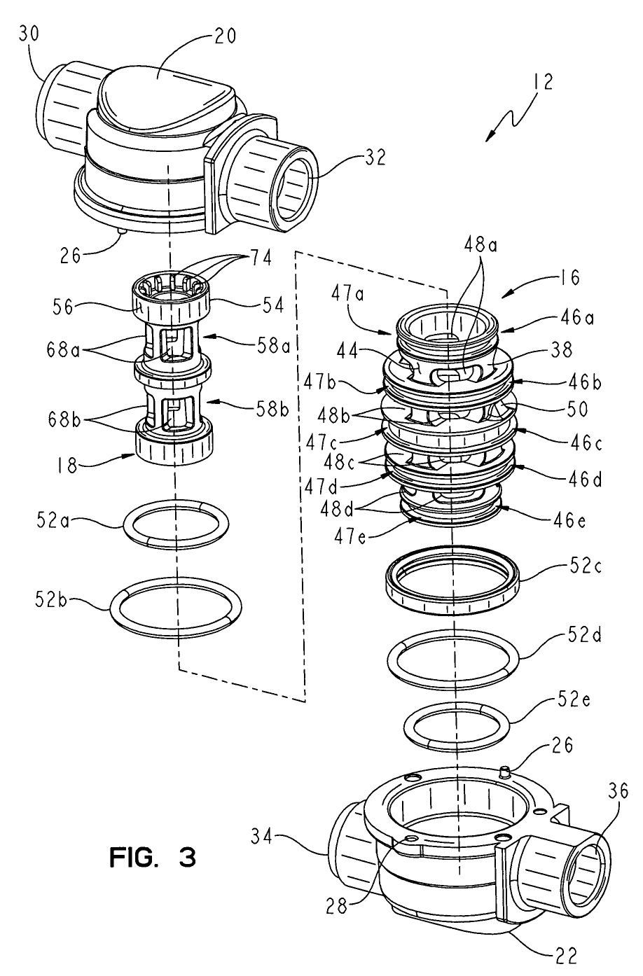

Referring initially to FIGS. 1 and 2, a mixing valve 10 according to the present disclosure includes a pressure balance proportioning valve 12 having a valve body 14 configured to receive a first valve member 16 and a second valve member 18. The valve body 14 may be received within a housing of the type detailed in U.S. Pat. No. 5,725,010, the disclosure of which has been expressly incorporated by reference herein. Illustratively, valve body 14 includes a first valve body portion 20 and a second valve body portion 22. Coupling first valve body portion 20 to second valve body portion 22 defines an internal chamber 24 for receiving the first and second valve members 16 and 18, respectively. Locating pins 26 may be received within apertures 28 to facilitate proper orientation of first valve body portion 20 relative to second valve body portion 22 (FIG. 3).

First valve body portion 20 includes a first fluid inlet 30 and a first fluid outlet 32. Similarly, second valve body portion 22 includes a second fluid inlet 34 and a second fluid outlet 36. The first and second fluid inlets 30 and 34 illustratively comprise two laterally spaced apart, downwardly extending hollow tubular extensions configured to receive hot and cold water, respectively. Conventional check valves (not shown) may be received within the inlets 30 and 34 to prevent cross-flow of water from the first fluid inlet 30 into the second fluid inlet 34, and vice versa.

The first and second fluid outlets 32 and 36 illustratively comprise two laterally spaced apart, upwardly extending hollow tubular extensions configured to dispense hot and cold water, respectively. The fluid outlets 30 and 36 are configured to receive seal elements or seats which are biased upwardly by springs (not shown). The seats and springs may be of conventional design and illustratively of the type detailed in U.S. Pat. No. 5,725,010.

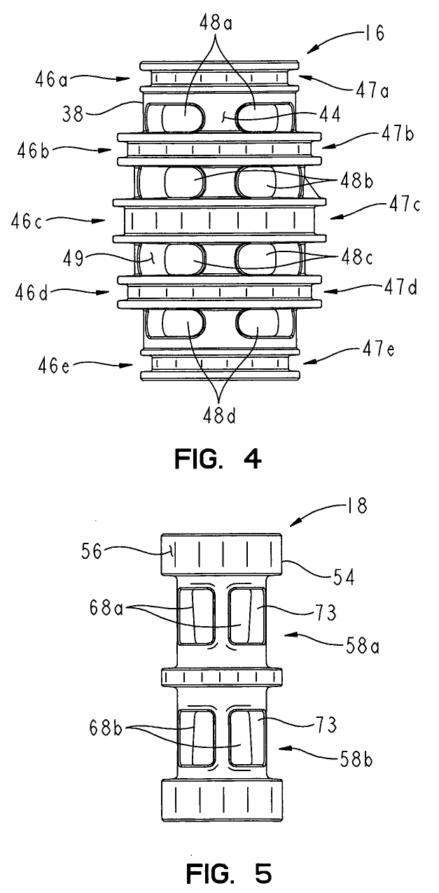

First valve member or sleeve 16 is non-rotatably disposed within internal chamber 24. As shown in FIGS. 2-4, first valve member 16 includes a substantially cylindrical wall 38 having an inner surface 40 which defines an internal passage 42 with an inner diameter d1. Cylindrical wall 38 of first valve member 16 also includes an outer surface 44. A plurality of annular members 46a, 46b, 46c, 46d, 46e extend radially outwardly from the outer surface 44 and each include a receiving groove 47a, 47b, 47c, 47d, 47e, respectively. First valve member 16 further includes a plurality of axially spaced apertures 48a, 48b, 48c, and 48d. Apertures 48a are aligned with first fluid inlet 30, apertures 48b are aligned with first fluid outlet 32, apertures 48c are aligned with second fluid outlet 36, and apertures 48e are aligned with second fluid inlet 34. The apertures 48 illustratively include tapered or beveled surfaces 49 and are circumferentially elongated for increased fluid flow. Illustratively, a rib 50 may extend outwardly from the outer surface 44 and is a result of a gate formed during the injection molding process described herein.

As illustrated in FIGS. 2 and 3, first valve member 16 further illustratively includes sealing rings 52a, 52b, 52c, 52d, and 52e which are respectively received within grooves 47a, 47b, 47c, 47d, and 47e of annular members 46a, 46b, 46c, 46d, and 46e. Illustratively, the sealing rings 52 each comprise a resilient o-ring which fluidly seals with an inner surface 53 of valve body 14 (FIG. 2). More particularly, sealing rings 52a and 52b sealingly engage the first valve body portion 20, and sealing rings 52d and 52e sealingly engage the second valve body portion 22. Sealing ring 52c sealingly engages both first and second valve body portions 20 and 22. As such, sealing ring 52c seals any gap between the first and second valve body portions 20 and 22. Annular members 46a, 46b, 46c, 46d, 46e and sealing rings 52a, 52b, 52c, 52d, 52e cooperate to separate first fluid inlet 30, second fluid inlet 34, first fluid outlet 32, and second fluid outlet 36.

Second valve member or inner spool 18 is slidably mounted within first valve member 16, as shown in FIGS. 2 and 3. Also as illustrated in FIGS. 2, 3 and 5, second valve member 18 includes a substantially cylindrical wall 54 including an outer surface 56 having an outer diameter d2. Illustratively, the difference between the outer diameter d2 of second valve member 18 and the inner diameter d1 of first valve member 16 is no more than 0.002 inches in order to facilitate fluid sealing therebetween. More particularly, the outer diameter d2 is precision machined to be between a value equal to inner diameter d1 and 0.002 inches less than inner diameter d1. Outer surface 56 further includes two axially spaced annular grooves 58a, 58b. Grooves 58a, 58b provide selective fluid communication between first fluid inlet 30 and first fluid outlet 32, and between second fluid inlet 34 and second fluid outlet 36 depending upon the axial position of second valve member 18.

Cylindrical wall 54 further includes an inner surface 60 defining a first fluid conduit 62 and a second fluid conduit 64 separated by an internal wall or spacer 66. A plurality of apertures 68a and 68b are formed within cylindrical wall 53 and communicate with grooves 58a and 58b, respectively, to allow fluid flow from each inlet 30 and 34 to exert pressure against opposing sides 70 and 72 of the spacer 66. In other words, pressure from a first fluid passing through first fluid inlet 30 exerts pressure against surface 70, while pressure from a second fluid passing through second fluid inlet 34 exerts pressure against surface 72 in opposition to the first fluid pressure. In this way, the pressure within each outlet 32 and 36 is substantially equalized in the movement of second valve member 18. Illustratively, apertures 68 include radially outwardly extending walls 73 and are axially elongated to provide an increased range of fluid flow.

In one illustrative embodiment, a plurality of ribs 74 are supported by opposing ends of second valve member 18. Ribs 74 provide support for the outer diameter of the second valve member 18 during the precision machining process detailed below.

First and second valve members 16 and 18 are illustratively formed of an injection molded thermoplastic. In an alternate embodiment, the second valve member 18 may be formed of a metal, such as stainless steel. Examples of thermoplastics for valve members 16 and 18 include: polyphenylene sulfide (PPS): especially Fortron 6165 PPS which is commercially available from Ticona Manufacturing of Wilmington, N.C.; modified polyphenylene (m-PPE), such as Xyron G703H m-PPE which is commercially available from Asahi Kasei Corporation of Fowlerville, Mich.; polyvinyl chloride (PVC), such as Fiberloc 81510 which is commercially available from PolyOne Corporation of Avon Lake, Ohio; and polysulfone (PSU), such as Udel GF-120 PSU which is commercially available from Solvay Plumbing of Alpharetta, Ga. It should be appreciated, however, that this list is for illustrative purposes only and that the present invention is not limited to these particular materials.

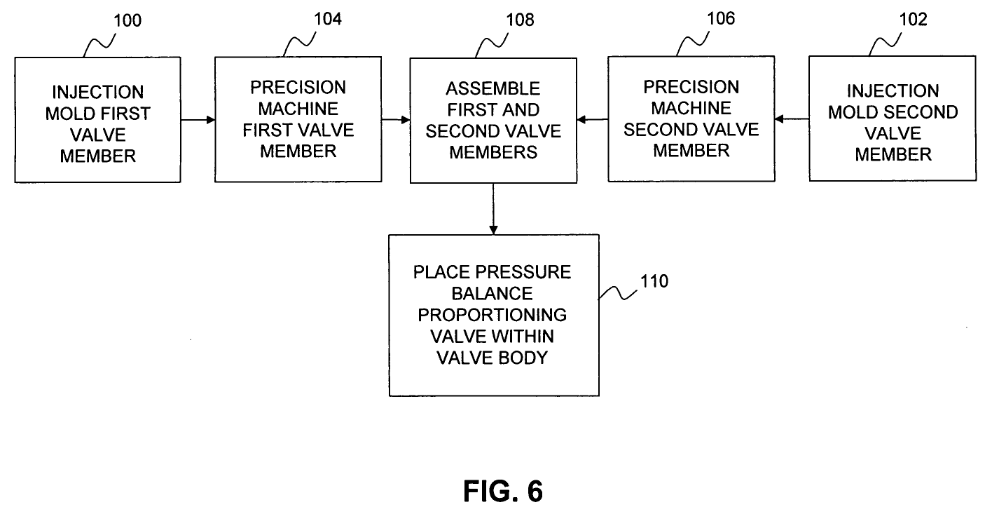

FIG. 6 is a flow chart showing an illustrative method of manufacturing the pressure balance proportioning valve 12. The process begins at step 100 by injection molding the first valve member 16. This step includes providing a mold (not shown), injecting heated thermoplastic into a cavity of the mold, ejecting the molded first valve member from the mold, and cooling the first valve member. At step 102, the second valve member 18 is injection molded in a manner similar to the first valve member 16 within a single mold, illustratively a multiple valve member mold. Injection molding of the second valve member 18 may occur simultaneously with injection molding of the first valve member 16. Alternatively, the injection molding of valve members 16 and 18 may occur in separate molds.

The process continues at step 104 where the inner surface 40 of the first valve member 16 is precision machined, illustratively through a conventional cutting operation. More particularly, the inner surface 40 of the first valve member 16 is machined to predetermined inner diameter d1. Similarly, at step 106 the outer surface 56 of second valve member 18 is precision machined to predetermined outer diameter d2. More particularly, valve members 16 and 18 are machined such that outer diameter d2 is no more than approximately 0.002 less than the inner diameter d1. Again, steps 104 and 106 may be accomplished simultaneously. The process continues to step 108 where the first and second valve members 16 and 18 are assembled by sliding the second valve member 18 within the passage 42 of the first valve member 16. The reception of the second valve member 18 within the first valve member 16 creates a pressure balance proportioning valve or subassembly 12. At step 110, the subassembly 12 is positioned within the valve body 14. As detailed above, the valve body 14 comprises two portions 20 and 22 coupled together and defining an internal chamber 24 within which the first valve member 16 of the subassembly 12 is non-rotatably disposed.

Although the invention has been described in detail with reference to certain preferred embodiments, variations and modifications exist within the spirit and scope of the invention as described and defined in the following claims.

1. A valve for balancing pressure between a first fluid and a second fluid, the valve comprising:
a valve body including a first fluid inlet for receiving the first fluid, a second fluid inlet for receiving the second fluid, a first fluid outlet, a second fluid outlet, and an internal chamber in fluid communication with the first fluid inlet, the second fluid inlet, the first fluid outlet, and the second fluid outlet;
a first valve member molded from a polymer and positioned within the chamber, the first valve member having an inner surface defining an internal passage in fluid communication with the first fluid inlet, the second fluid inlet, the first fluid outlet, and the second fluid outlet;
a second valve member at least partially disposed within the internal passage of the first valve member, and slidably moveable relative to the first valve member, the second valve member having an outer surface, a first fluid conduit in fluid communication with the first fluid inlet and the first fluid outlet, a second fluid inlet separated from the first fluid conduit and in fluid communication with the second fluid inlet and the second fluid outlet; and
wherein the outer surface of the second valve member and the inner surface of the first valve member are machined to substantially the same dimensions to provide a movable seal between the second valve member and the first valve member.

2. The valve of claim 1, wherein:
the first valve member includes a plurality of apertures;
the second valve member includes a plurality of apertures; and
the apertures of the first valve member and the second valve member are selectively alignable to control the flow of water to the first and second fluid outlets.

3. The valve of claim 2, wherein at least one of the plurality of apertures of the first valve member is elongated, at least one of the plurality of apertures of the second valve member is elongated.

4. The valve of claim 2, wherein at least one of the plurality of apertures of the second valve member includes a radially outwardly extending wall.

5. The valve of claim 2, wherein at least one of the plurality of the apertures of the first valve member include tapered outer surfaces.

6. The valve of claim 1, wherein the second valve member further includes opposing ends, and a plurality of ribs on the ends.

7. The valve of claim 1, wherein the first valve member includes a substantially cylindrical wall defining the inner surface.

8. The valve of claim 7, wherein first valve member further includes a plurality of annular members extending radially outwardly from the substantially cylindrical wall.

9. The valve of claim 8, wherein the first valve member further includes sealing rings supported by the annular members.

10. The valve of claim 1, wherein the second valve member comprises a spool including a substantially cylindrical wall having an inner surface defining the first and second fluid conduits.

11. The valve of claim 1, wherein the second valve member is molded from a polymer.

12. A method of forming a pressure balance valve assembly, the method comprising the steps of:
injection molding a first valve member from a polymer, the first valve member including an inner surface defining an internal passage;
precision machining the inner surface of the first valve member to a first diameter;
injection molding a second valve member from a polymer, the second valve member including an outer surface; and
precision machining the outer surface of the second valve member to a second diameter, wherein the second diameter is substantially equal to the first diameter.

13. The method as recited in claim 12, wherein the difference between the first diameter and the second diameter is no more than approximately 0.002 inches.

14. The method as recited in claim 12, the method comprising the additional step of:
subjecting the second valve member and the first valve member to a first fluid wherein the first valve member and the second valve member expand before precision machining either one of the first or the second valve members.

15. The method as recited in claim 12, the method comprising the additional steps of:
providing a multiple valve member mold; and
simultaneously injection molding the first and the second valve members within the multiple valve member mold.

16. The method as recited in claim 12, the method comprising the additional step of:
inserting the second valve member within the first valve member for sliding movement, wherein the outer surface of the second valve member seals against the inner surface of the first valve member.

17. A valve assembly comprising:
a sleeve molded from a polymer and including a precision machined inner surface defining a passage;
a spool including a precision machined outer surface; and
wherein the outer surface of the spool sealingly engages the inner surface of the sleeve when the spool is slidably received within the passage of the sleeve.

18. The valve assembly of claim 17, wherein the spool further includes opposing ends and a plurality of ribs on the ends.

19. The valve assembly of claim 17, wherein the spool further includes a cylindrical wall defining first and second fluid conduits and a plurality of apertures.

20. The valve assembly of claim 19, wherein at least one of the plurality of apertures is elongated.

21. The valve assembly of claim 19, wherein at least one of the plurality of the apertures includes tapered outer surfaces.

22. The valve assembly of claim 17, wherein the spool is molded from a polymer.
